(19) United States
(12) Patent Application Publication
(10) Pub. No.: US 2007/0083697 A1
(43) Pub. Date: Apr. 12, 2007

(54) Flash memory management

(75) Inventors: Andrew Birrell, Los Altos, CA (US); Charles Thacker, Palo Alto, CA (US); Edward P. Wobber, Menlo Park, CA (US); Michael A. Isard, San Francisco, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, CA (US)

(21) Appl. No.: 11/245,919

(22) Filed: Oct. 7, 2005

(51) Int. Cl. G06F 12/00

(52) U.S. Cl. 711/103; 711/170

(57) ABSTRACT

Flash memory is managed utilizing memory management data structures residing in volatile memory of a flash memory device. The memory management data structures are created and updated each time power is supplied to the memory device. During write operations to the flash memory, specific locations in the flash memory are updated to reflect the current status of the flash memory. When power is interrupted, the memory management data structures are recreated upon reapplication of power. The flash memory is scanned and the information obtained from the specific locations in the flash memory is utilized to construct the memory management data structures. No bad block tables are required. Flash memory is managed to provide relatively good random write performance and to accommodate power interruptions. Applications include the use of flash memory for general purpose computing and devices in which power can fail at any time (due to being unplugged for example).

### TECHNICAL FIELD

The technical field generally relates to electronics and more specifically to memory management of flash memory devices.

### BACKGROUND

Flash memory is a form of electrically erasable programmable read only memory (EEPROM). Unlike typical EEPROM, which is erasable one byte at a time, flash memory is typically erased one block at a time. Block sizes vary for various flash memory devices. Management of flash memory is often specific to the memory device. Flash memory devices are typically small, light weight, maintain state in the absence of power, and consume low amounts of power. Thus, flash memory is appropriate for devices such as mobile devices, battery powered devices, devices desiring low power consumption, digital cameras, MP3 players, and/or small devices, for example.

Use of USB flash memory in such devices typically involves sequential writes of relatively large amounts of data and is not very conducive to random write operations of relatively small amounts of data. Further, many flash memory devices can be plugged and unplugged from other devices via the USB interface while applications are running. Thus, it is possible for a USB flash memory device to lose power (e.g., via being unplugged) in the middle of a read or write operation. This could lead to unrecoverable errors.

### SUMMARY

Memory is managed to gracefully accommodate power interruptions and to provide relatively good random write performance. Memory management data structures are created and updated each time power is supplied to a memory device, such as a flash memory device. In an exemplary embodiment, the memory management data structures are formed in volatile memory. Thus, the memory management data structures are lost when power is lost, and are recreated each time power is subsequently supplied. During write operations to the flash memory, specific locations in the flash memory are updated to reflect the current status of the flash memory. When power is interrupted, the memory management data structures are recreated upon reapplication of power. The flash memory is scanned and the information obtained from the specific locations in the flash memory is utilized to construct the memory management data structures.

### BRIEF DESCRIPTION OF THE DRAWINGS

The foregoing and other objects, aspects and advantages will be better understood from the following detailed description with reference to the drawings, in which:

FIG. 1 is block diagram of an exemplary flash memory device;

FIG. 2 is a block diagram of another exemplary embodiment of a flash memory device;

FIG. 3 is an illustration of an exemplary flash memory data structure comprising blocks and pages;

FIG. 4 is a diagram of an exemplary designation of pages in a block;

FIG. 5 is a diagram of an exemplary data and metadata structure of a page;

FIG. 6 is a diagram of an exemplary data structure for a summary page;

FIG. 7 is an illustration of an exemplary memory management data structure relating logical block addresses (LBAs) to flash page addresses;

FIG. 8 is an illustration of an exemplary memory management data structure depicting free blocks;

FIG. 9 is an illustration of an exemplary memory management data structure depicting the number of valid pages in a block;

FIG. 10 is an exemplary memory management data structure depicting page sequence numbers associated with pages in a block;

FIG. 11 is an illustration of an exemplary memory management data structure depicting an active block and an active page;

FIG. 12 is a flow diagram of an exemplary process for scanning blocks;

FIG. 13 is a flow diagram of an exemplary process for scanning a summary page;

FIG. 14 is a flow diagram or an exemplary process for performing a full block scan;

FIG. 15 is a flow diagram of an exemplary process for performing LBA mapping; and

FIG. 16 is a flow diagram of an exemplary process for assigning an active block and an active page.

### DETAILED DESCRIPTION OF ILLUSTRATIVE EMBODIMENTS

Memory management is described herein as applied to flash memory. However, it is to be understood that the application of memory management as described herein should not be limited thereto. The herein described management of memory is application to any appropriate type of storage means, such as NAND flash memory, NOR flash memory, non-flash memory, dynamic memory, volatile memory, nonvolatile memory, semiconductor memory, magnetic memory, hard disk memory, floppy disk memory, optical memory, or the like, for example.

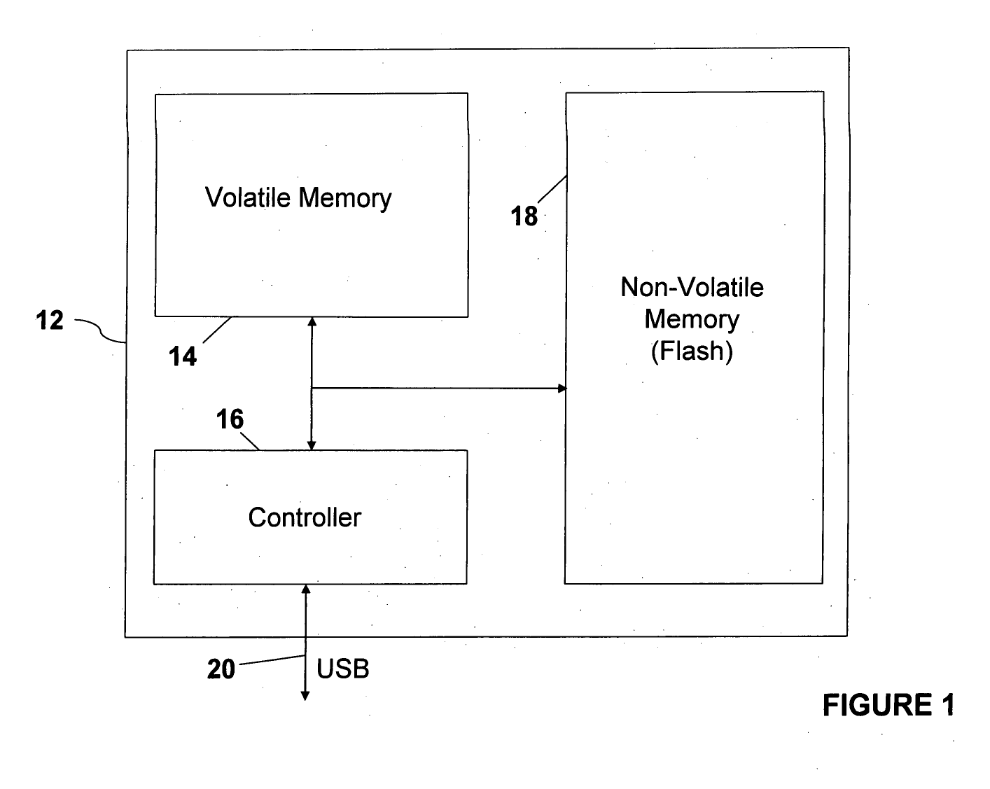

FIG. 1 is a block diagram of an exemplary flash memory device 12 comprising a volatile memory portion 14, a controller portion 16, and a nonvolatile memory portion 18. In an exemplary embodiment, the nonvolatile memory portion 18 comprises flash memory. However, any appropriate memory can be utilized. It is not necessary that the volatile memory portion 14 comprise volatile memory, and thus in an alternate embodiment, the volatile memory portion 14 comprises nonvolatile memory. Further, in exemplary embodiments, the volatile memory portion 14 and/or the nonvolatile memory portion 18 can comprise databases. The flash memory device 12 can be implemented in a single processor, or multiple processors. Multiple processors can be distributed or centrally located. Multiple processors can communicate wirelessly, via hard wire, or a combination thereof. For example, the controller portion 16 of the flash memory device 12 can be implemented via multiple distributed processors.

As described in more detail below, the controller portion 16 manages access to the flash memory portion 18. The term “access” as used herein comprises read, write, erase, or a combination thereof. The controller portion 16 also constructs memory management data structures within the volatile memory portion 14.

The flash memory device 12 is coupleable via interface 20 to any appropriate device desiring access (accessing device not shown in FIG. 1) to the flash memory device 12. The accessing device (e.g., digital camera or MP3 player) is coupled to the memory controller portion 16 via interface 20. The interface 20 can comprise any appropriate interface, such a Universal Serial Bus (USB), for example. In an exemplary embodiment, the controller portion 16 is transparent to the accessing device and the accessing device “thinks” is it interfaced directly to the flash memory 18. In another exemplary embodiment, the controller 16 emulates disk memory, and the accessing device “thinks” is it interfaced directly to a disk. The interface 20 can be a wireless link, a hardwired interface, or a combination thereof.

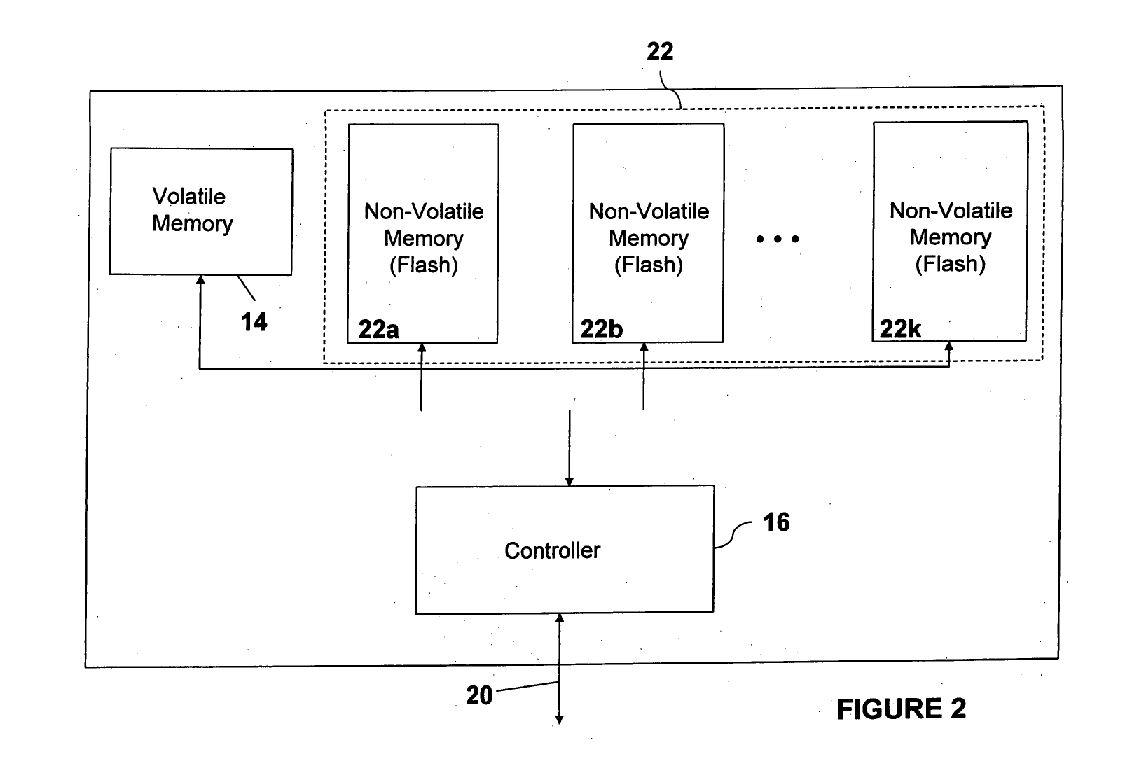

FIG. 2 is a block diagram illustrating another exemplary embodiment of a flash memory device. In the configuration depicted in FIG. 2, the flash memory device comprises multiple nonvolatile memory portions 22. In an exemplary embodiment, the flash memory device comprises means to separately access each portion (22a-22k) of the nonvolatile memory portion 22. Separate portions 22a-22k can represent separate flash memory portions on a single chip, separate chips, or a combination thereof. In an exemplary embodiment, Separate access to each portion of the nonvolatile memory portion 22 can be implemented by any appropriate means, such as by separate enable/disable switches, for example. Separate access to selected portions of the nonvolatile memory portion 22 allows multiple functions to be performed concurrently. For example, selected portions of the nonvolatile memory portion 22 can accept commands, while other portions can be performing operations requiring longer amounts of time.

Referring again to FIG. 1, for the sake of simplicity, the nonvolatile memory portion 18 also is referred to herein as flash memory. In an exemplary embodiment, when power is applied to the flash memory device 12, the controller 16 scans the flash memory 18. The controller 16 utilizes information obtained from scanning the flash memory 18 to construct memory management data structures in the volatile memory portion 14. The controller portion 16 obtains information pertaining to the status of blocks and pages of the flash memory 18 from selected pages of selected blocks of the flash memory 18.

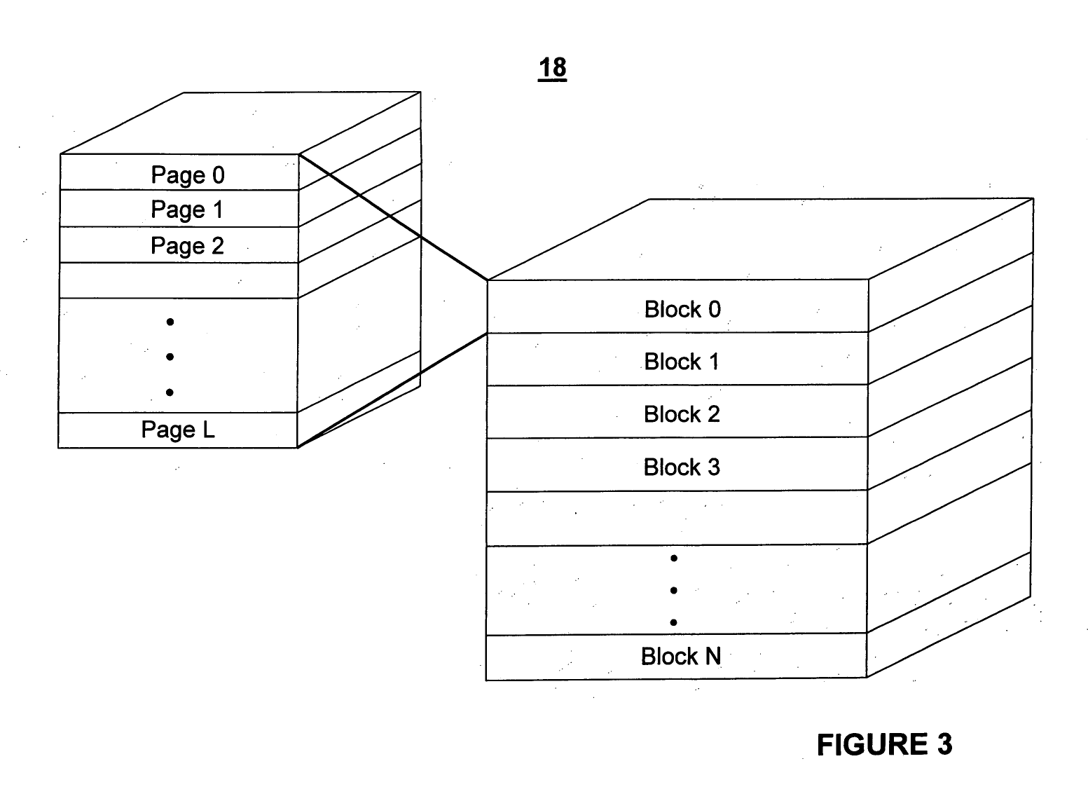

FIG. 3 is a diagram of the flash memory 18 illustrating an exemplary data structure for blocks and pages. The flash memory 18 comprises a fixed number of blocks. Each block comprises a fixed number of pages. In an exemplary embodiment, the flash memory 18 comprises “N” plus 1 blocks and each block comprises “L” plus 1 pages, as depicted in FIG. 3. Each page comprises a fixed number of bytes. In an exemplary embodiment, the flash memory device comprises 4096 blocks (4K blocks) per flash memory portion 18 (i.e., N=4095), and each block comprises 64 pages (i.e., L=63). Accordingly, each flash memory portion 18 comprises 256K pages (4K×64). Further, each page comprises 2112 bytes, (2 KB, designated for data and 64 B designated for metadata). However, various other configurations are envisioned.

Before data can be written into flash memory, memory must be erased. More specifically, before a block can be used for writing, the block must be erased. Flash memory can be written a page at a time. Flash memory is erased a block at a time. Thus, erase operations are performed on a block basis, and program (write) operations are performed on a page basis. Read operations also are performed on a page basis. Pages in a block are written sequentially from low to high address. Thus, referring to FIG. 3, page 1 would be written before page 2 could be written. Once a page has been written, earlier pages in the block can no longer be written until after the next erasure (of the block). As described in more detail below, the sequential write condition is utilized to determine erasure failures. Flash memory cells are given a value of binary 1 when erased. When programmed (written), the cells are given a value of binary 0.

Referring now to FIG. 1 and FIG. 3, in an exemplary embodiment, a read operation involves reading an entire page from the flash memory 18. The contents of the page are copied to a register of the controller portion 16. In this exemplary embodiment, the register size is 2112 bytes (2 KB+64 bytes). The contents of the register are available to be transferred to an access device via the interface 20 (e.g., USB). The register's contents can be transferred in its entirety or any portion thereof can be transferred. As described above write operations are performed in sequential page order. A page can be written up to four times between erasures. However, the same portion of a page can not be written until an erasure has occurred. That is, a cell can not be written into twice, for example, a zero can not be turned into a one (without erasing). Thus, once a memory cell is written with a 0, the cell can not be written with a 1 until an erasure occurs. Write operations are performed by the controller portion 16. Data to be written to the flash memory 18 is placed in a register in the controller 16, and the contents of the register are transferred to the flash memory 18. The contents of the resister can be transferred to the flash memory 18 in up to four transfers. Thus, a page can be written up to four times before an erasure, wherein no portion of the page is rewritten between erasures.

Various means can be used to ensure that data being read from the flash memory 18 is correct (e.g., has not been corrupted). In an exemplary embodiment, error correction and detection, referred to as ECC, is utilized during a read operation. Any appropriate ECC scheme can be used. In an exemplary embodiment, double-bit error detection and single-bit error correction Hamming code is used. When a page of data is read from the flash memory 18, ECC is performed on the entire page by the controller portion 16. If no errors or detected, or if detected errors are corrected, the page is determined to be good. If an error is detected and can not be corrected, the page is determined to be bad.

Another means for ensuring that the data read from the flash memory 18 is correct is a scheme, referred to strong error detection, employing a hash function. A hash function is a function that converts a variable length input into a fixed length output, referred to as the hash value. Within mathematical limits, two different inputs to a hash function will not result in the same hash value. In an exemplary embodiment, a cryptographic hash function, such as the well known MD5 or SHA-1 for example, is used. When data is written to a page, at least a portion of the data is operated on by a hash function. This operation is referred to as hashing the data. The resulting hash value is stored in the page along with the data. The hash value is stored in the metadata portion of the page. Hashing is performed by the controller portion 16. When data is read from a page, the controller 16 hashes the data using the same hash function as was used to write the data. The resulting hash value is compared to the hash value stored in the metadata portion of the page. If the two hash values match, the data is determined to be good. If the two hash values differ, the data is determined to be bad.

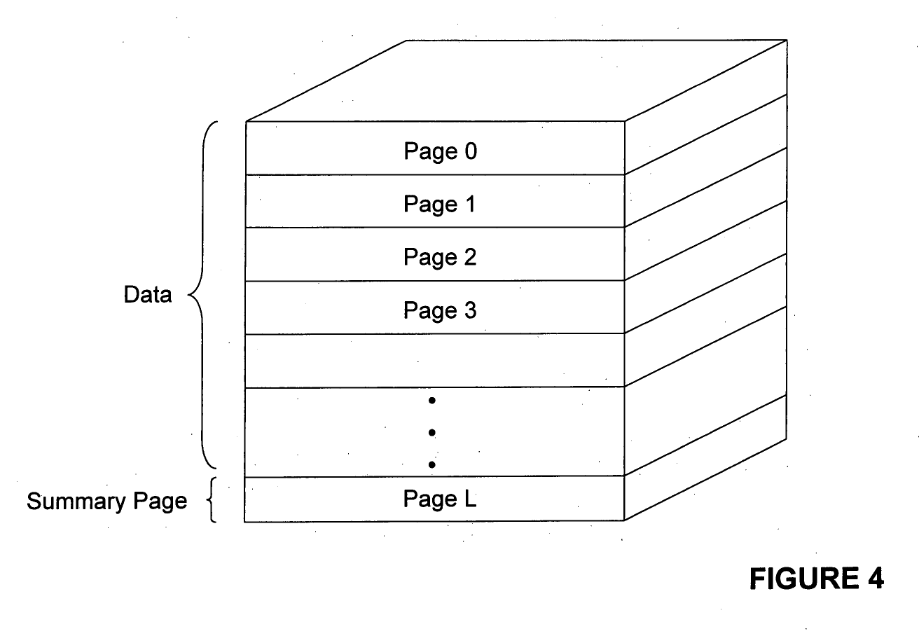

FIG. 4 is a diagram of an exemplary designation of pages in a block. Pages in each block are designated either as data or summary pages. In the exemplary embodiment described herein, as depicted in FIG. 4, the last page (page L) of each block is designated as the summary page. All other pages (pages 0 through L-1) are designated as data pages. Of the data pages of each block, page 0 is treated specially, as described below. All of the data pages are available for general use, such as reading, writing, and erasing. Page 0 of each page contains block specific information and page L of each block contains summary information pertaining to the block and to pages the in the block.

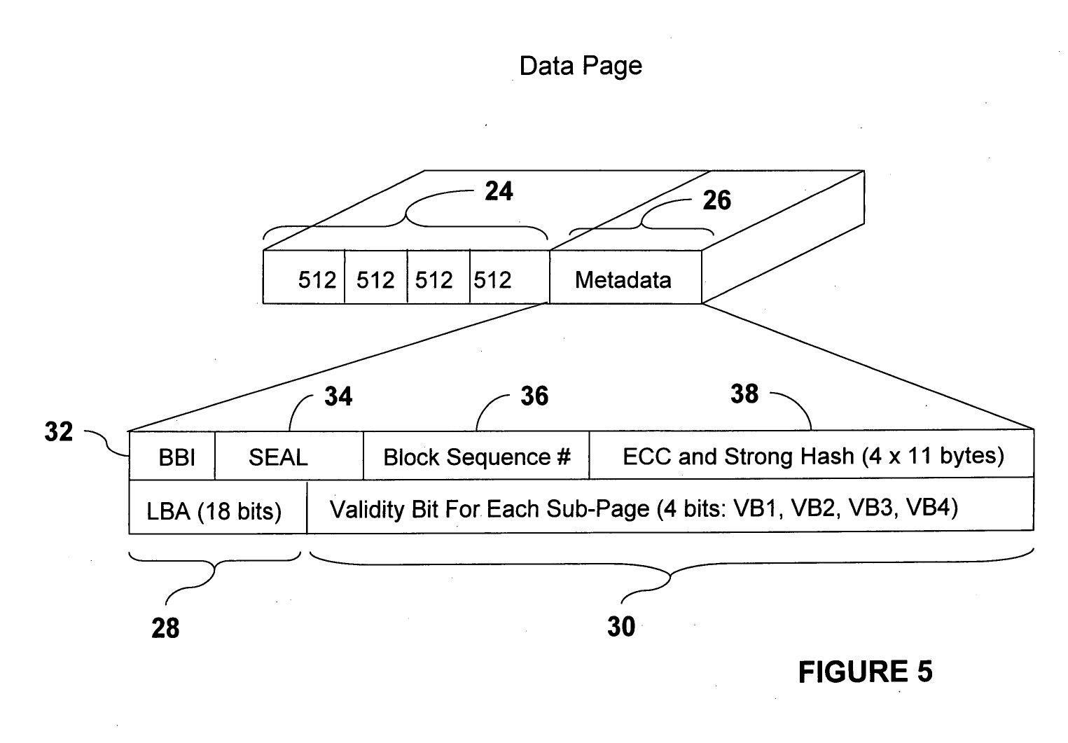

FIG. 5 is a diagram of an exemplary data structure of a page comprising a payload portion 24 and a metadata portion 26. FIG. 5 depicts an exemplary data structure for all pages in the flash memory other than page L. The payload portion 24 comprises four sub-pages. Each sub-page is 512 bytes in size. That is, each sub-page can accommodate 512 bytes of data. Thus, the payload portion 24 is 2048 bytes (2 KB) in size. The metadata portion 26 is 64 bytes in size. The metadata portion 26 comprises a bad block indicator (BBI) portion 32, a block sequence number portion 36, a seal portion 34, an error correction and detection portion 38, and a logical block address (LBA) portion 28 that is 18 bits in size and is capable of accommodating the LBA of the page. The metadata portion 26 also contains a valid sub-page portion 30 that is 4 bits in size. The valid sub-page portion 30 is capable of accommodating 4 bits, validity bit 1 (VB1), validity bit 2 (VB2), validity bit 3 (VB3), validity bit 4 (VB4), each bit indicating whether a respective sub-page is valid or not. The error detection and correction portion is subdivided into 4 segments: one per potential write of the page. (In practice, most pages will only be written once.) On reads, only the most recently written (e.g. last) segment is applied. The error detection code covers the page data and metadata. The ECC covers the data, metadata, and error detection code. Note that content depicted in FIG. 5 is not found in all pages of a block. For example, as described below, some content is found only in page 0 of a block.

If a block is bad when tested after manufacture, page 0 or page 1 of that block is marked to indicate that the block is bad. The BBI portion 32 comprises an indication of the status of the block as bad or good. The BBI portion 32 of a page is only relevant for the first two pages of a block. In an exemplary embodiment, if the BBI portion 32 is all binary 1's for both these pages, the block is good. If the block is bad, the BBI portion 32 will comprise other than all binary 1s for either page 0 or page 1. The block sequence number portion 36 is 32 bits in size. Each time a block is written for the first time after erasure, a global sequence number (e.g. across all blocks) is incremented, and the value is placed here. The identical block sequence number will be written into the metadata of the block summary page, when and if it is written. The block sequence number 36 is ignored for blocks other than the first or last block.

The seal portion 34 accommodates an indication of the erasure status of the block. The indicator is referred to as a seal. It is relevant only to page 0 of a block. A seal is a distinct bit pattern used to indicate that a block is either completely erased or not completely erased. When an erased block is “sealed,” the distinctive pattern is written into the seal portion 34 of the metadata portion 26 of page 0 of the block without ECC or error detection code 38. Any appropriate distinctive pattern can be used. When the block is first written after being sealed, the seal is set to all binary 0s.

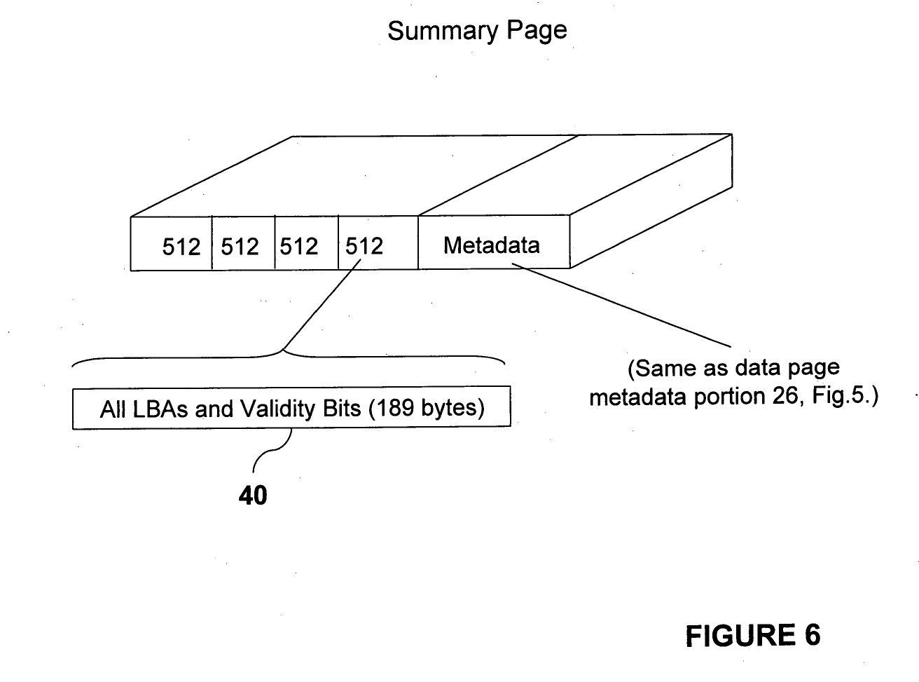

FIG. 6 is a diagram of an exemplary data structure for a summary page comprising a all logical block address (LBAs) portion and validity bits portion 40 and a metadata portion 26 equivalent to that described for data pages (e.g. FIG. 5). When the next to last page (page L-1) of a block is written, the last page (page L) is also written with summary information pertaining to the block. The LBA for each page in the block and the validity bits for each page in the block are written to the all LBAs and validity bits portion 40. The all LBAs and validity bits portion 40 is 189 bits in size, thus accommodating up to 3 bytes per page for each of 63 data pages in a block. A block sequence number is written to the block sequence number portion 36 of the metadata 26. The block sequence number is used to construct the memory management data structure during power-up.

Flash memory is managed in accordance with memory management data structures that are constructed in volatile memory. The memory management data structures are regenerated each time power is applied. During a power failure, it is envisioned that a sufficient energy reserve exists (e.g., via electrical capacitance) in the flash memory device to complete any write operation that may be in progress when power fails. It is not expected that any new operations will be started after a power failure until power is reapplied. The memory management data structures are depicted herein as tables. It is emphasized however, that the diagrams and illustration depicted herein are exemplary and not intended to imply a specific configuration and/or implementation.

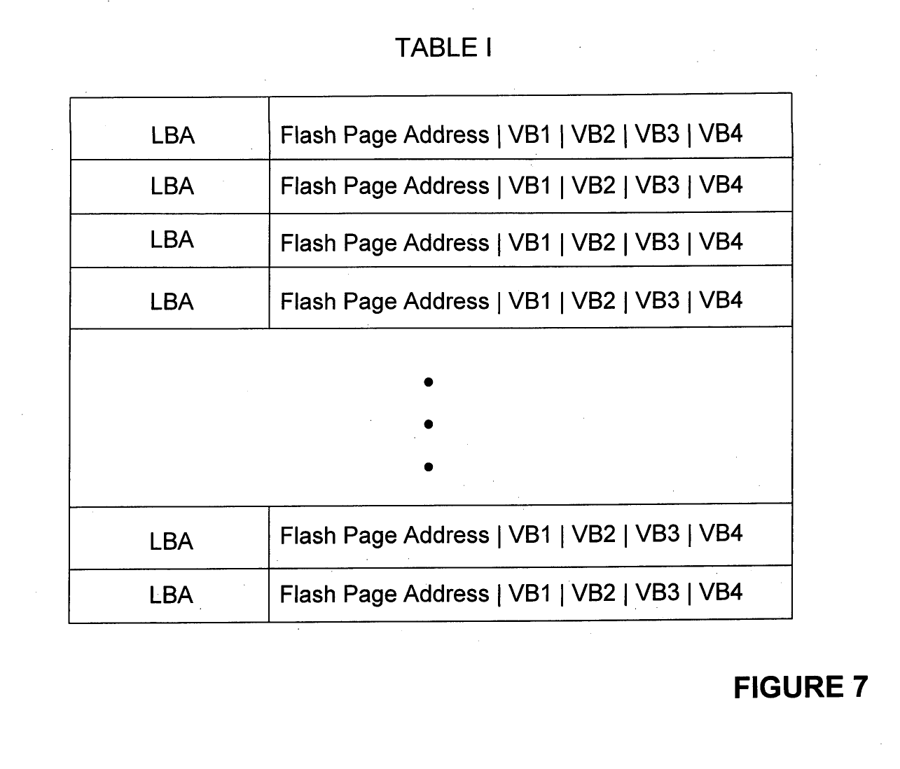

FIG. 7 is an illustration of an exemplary memory management data structure depicted as a table, Table I, relating logical block addresses (LBAs) to flash page addresses. It is envisioned that the LBA is an index used to address the table I, but is depicted as part of the Table I for clarity. An LBA is an address used by an access device (e.g., computer connected via USB, digital camera or MP3 player) to access memory. It is not uncommon for an access device to address memory via a USB in 4 KB segments. Flash memory however, is addressable in 2 KB segment. The memory management data structure represented by Table I maps the 4 k addressable LBAs to the 2K addressable flash memory page addresses. In an exemplary embodiment, Table I comprises 256K (256×1024) rows. Table I is indexed by the LBAs. Each row comprises an LBA and a corresponding flash memory page addresses. Each row also contains the validity bits, VB1, VB2, VB3, and VB4 for the respective 512 KB sub-pages of each flash memory page.

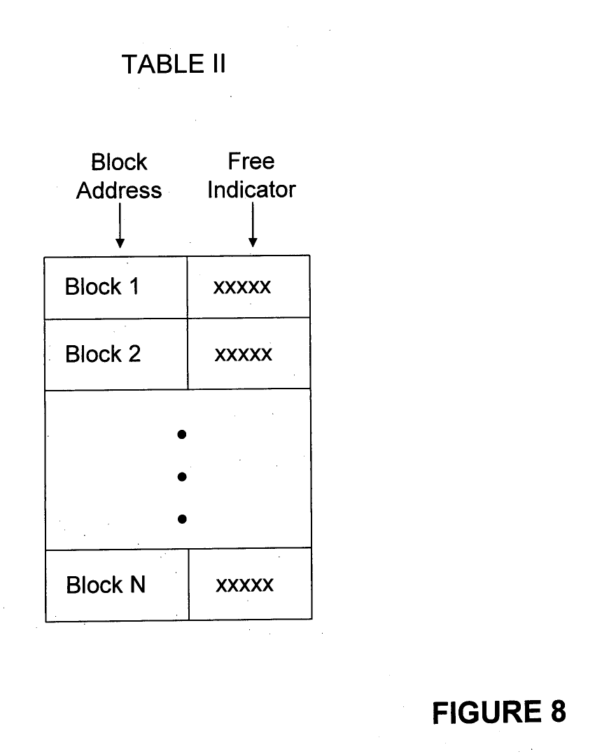

Another exemplary memory management data structure is depicted in FIG. 8 as Table II. Table II indicates which blocks are free. A free block is a block that has been erased and available for writing. In an exemplary embodiment, block 0 is not included in Table II. Block 0 is typically guaranteed by the manufacturer of the flash memory device to be entirely good. It is also typically guaranteed that block 0 can be written and erased correctly up to 1000 times. In an exemplary embodiment, block 0 is not used for general reading and writing of data. In an exemplary embodiment, a free block is indicated by a single bit in the free block column for each respective block.

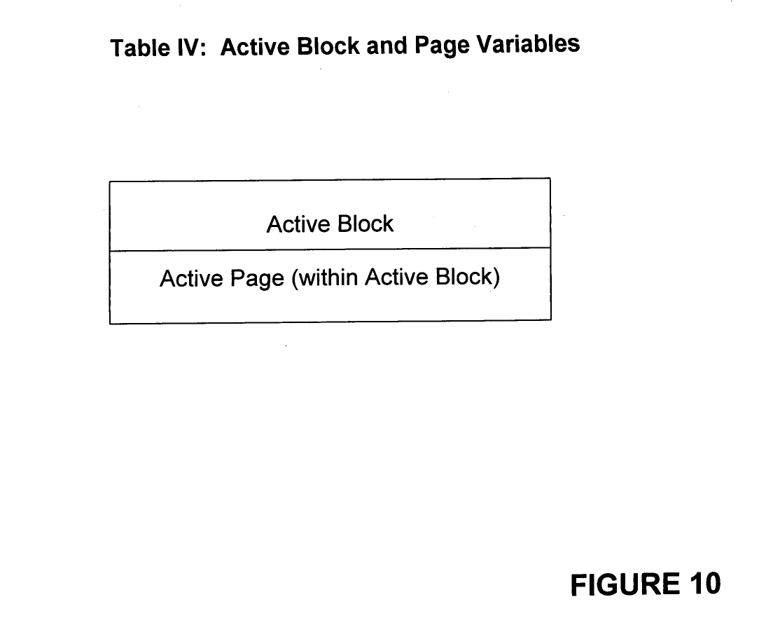

FIG. 10 is an illustration of an exemplary memory management data structure depicted as Table III. Table III indicates the number of valid pages in each block and if a block is abandoned. If a block is abandoned, a predetermined bit pattern is stored in the free indicator column of Table III. Any appropriate bit pattern can be use to indicate that a block is abandoned. A page is determined to be valid if the page contains utilizable contents (data). For example, if the contents of a page (old page) are written into another page (new page), the old page is determined to be invalid. The new page is determined to be valid. The value indicating the number of valid pages in a block is between 0 and 63 because each block contains 63 data pages. In an exemplary embodiment, when a new block is needed, the block having the smallest number of valid pages is determined to be a candidate for erasure. Erasing the block having the smallest number of valid pages will recover the most pages when erased. Table III also can be used to determine if a block is a candidate for erasure. In an exemplary embodiment, if a block contains any valid pages, it is not a candidate for erasure. It is envisioned that some erased blocks will be reserved. Reserved erased blocks can be used to handle long writes without having to compact and erase blocks during a transfer. Also, reserved erased blocks can be used to avoid rapid block reuse when the flash memory device is nearly full. Reserved erased blocks can also be used to handle blocks that become bad during the lifetime of the flash memory device.

FIG. 10 is an illustration of an exemplary memory management data structure depicted as Table IV. Table IV indicates the active block and the active page. At any time, there is at most one active block and one active page within the active block. The active block is the block currently being accessed. The active page is the first erased page within the active block. The active page is the page that will next be written in response to a write command. Although depicted as Table IV, it is envisioned that in an exemplary embodiment, active blocks and active pages can be implemented as dynamic runtime variables that are initialized during power-up scanning.

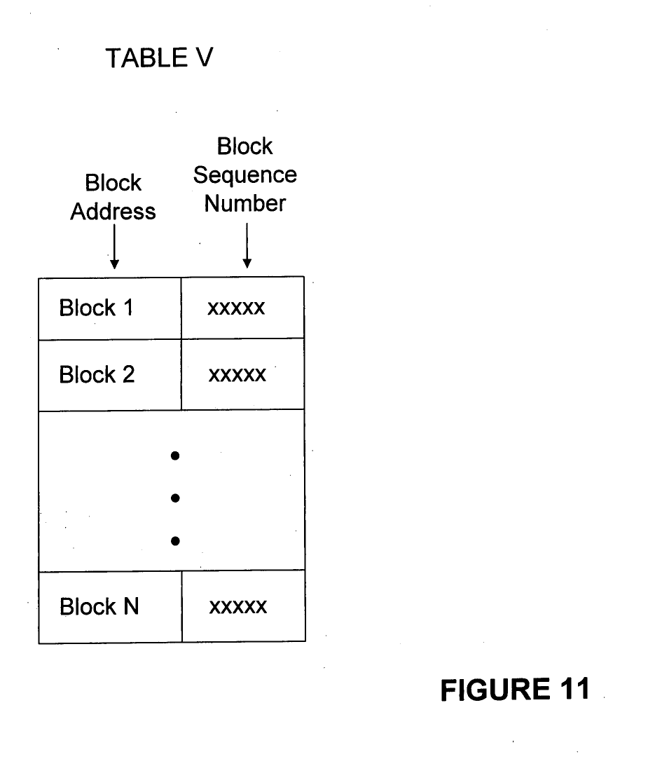

FIG. 11 is an illustration of an exemplary memory management data structure depicted as Table V. Table V indicates a block sequence number for each block. Table V is used while constructing the other memory management data structures (e.g., Tables I-IV). When a flash memory device is minted, it has no written blocks. For each subsequent block erase, a logical sequence number is incremented and written into the metadata of page 0 of the newly written block. The sequence number is also written, identically, into the block's summary page if or when that page gets written. The sequence number is used when the power-up scan detects two pages that claim to map to the same LBA. This conflict is resolved primarily by choosing the page in the block with the largest sequence number. If there are multiple such pages (necessarily in the same block), then the one with the largest page number is chosen. Table V comprises the block sequence number of all blocks encountered in the scan. This allows determination of the block number for any previously discovered candidate for a given LBA, so as to make the comparison above. In an exemplary embodiment, Table V is discarded after initialization.

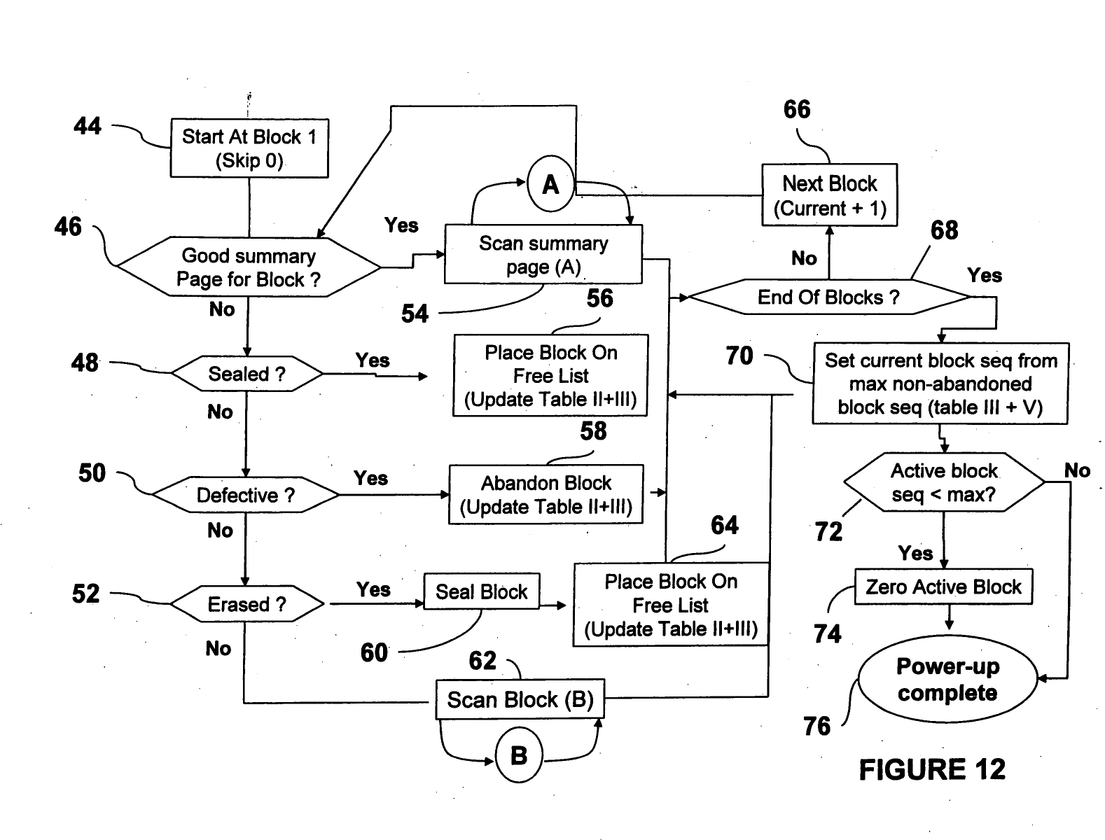

FIG. 12 is a flow diagram of an exemplary process for scanning blocks upon power up. Each block is scanned as part of the process to construct the memory management data structures. When power is applied, the flash memory (e.g., flash memory 18) of the flash memory device (e.g., flash memory device 12) is scanned (e.g., by the controller portion 16) to obtain information needed to construct the memory management data structures (e.g., in the volatile memory portion 14). In an exemplary embodiment, information about the blocks of the flash memory is obtained and information about the pages of blocks that have not been abandoned is obtained. Upon application of power, or appropriately thereafter, in an exemplary embodiment, the memory management data structure construction process starts by scanning the summary pages of blocks, and then, as appropriate, scanning other pages in blocks. It is emphasized that this sequence is exemplary and that any appropriate sequence of scanning blocks and pages can be used.

Upon power being applied, or appropriately thereafter, the blocks of the flash memory are scanned and the memory management data structures are created/populated. Each block is scanned to determine if the summary page of the block is good (step 46), if the block is sealed (step 48), if the block is defective (step 50), and if the block is erased (step 52). Appropriate data structures are created/updated in accordance with the results of each of these determinations.

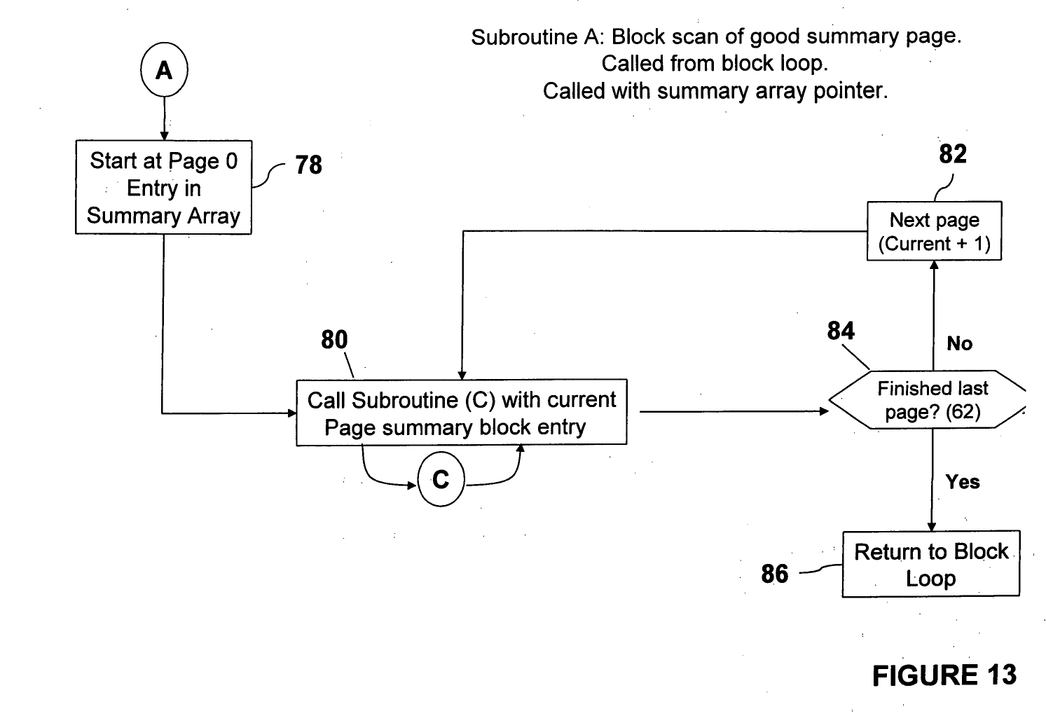

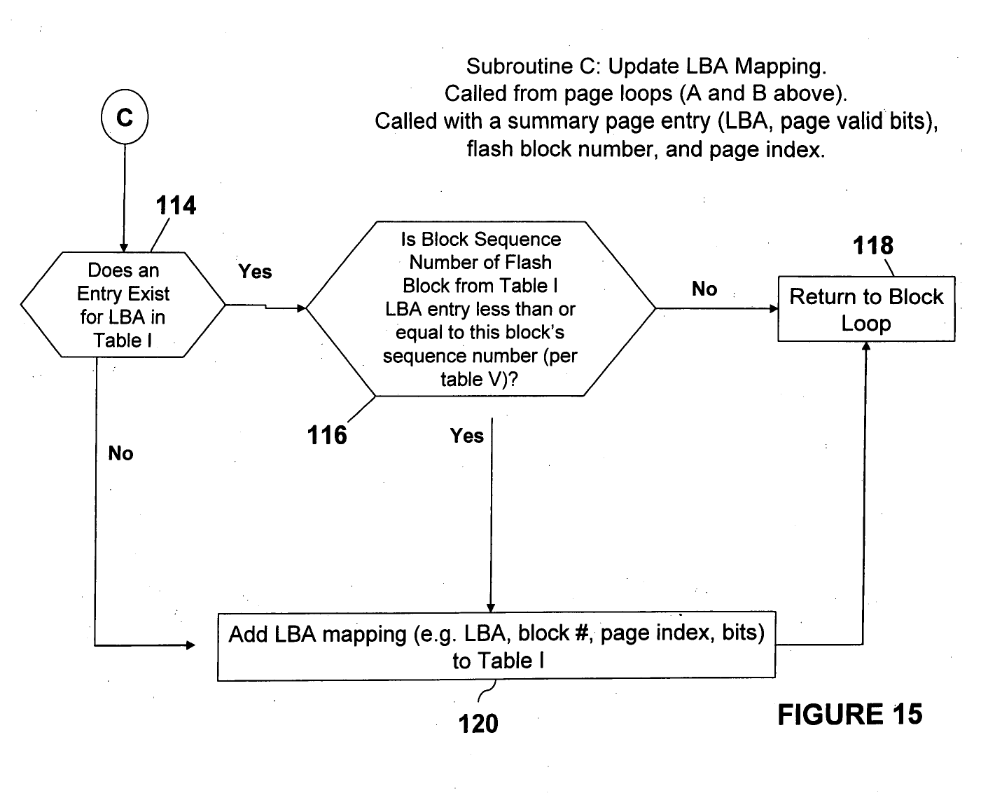

The process proceeds to block 1 at step 44. Block 0 is skipped. It is determined if the summary page of the block is good at step 46. If it is determined (step 46) that the summary page is good, the summary page is scanned at step 54. In an exemplary embodiment, the summary page is scanned in accordance with the exemplary flow diagram depicted in FIG. 13. The scan of the summary page starts at the entry for page 0, as depicted at step 78 of FIG. 13. The entries in the summary page are used to populate Table I at step 80. In an exemplary embodiment, Table I is populated in accordance with the exemplary process depicted in FIG. 15. It is determined, at step 114, if an entry exists in Table I for the LBA entry in the summary page. If it is determined (step 114) that no LBA entry exists, Table I is updated with the LBA entry in the summary page at step 120. This includes mapping all information pertaining to the LBA, such as the block number, the page indices, and validity bit information. If it is determined (step 114) that an LBA entry exists in Table I for the LBA entry in the summary page, it is determined, at step 116, if the block sequence number of the associated flash memory block is less than or equal to the block sequence number as denoted in Table V. If yes, Table I is populated at step 120. If no, as depicted at step 118, the process proceeds to step 80 of FIG. 13.

At step 84, it is determined if there are more pages in the block. If there are more pages, the process proceeds to the next page at step 82. The process proceeds to step 80 and populates Table I in accordance with the exemplary flow diagram depicted in FIG. 15 as described above. If it is determined (step 84) that there are no more pages, the process proceeds, as depicted at step 86, to step 54 of FIG. 12. At step 68 it is determined if there are more blocks to scan. If it is determined (step 68) that there are more blocks to scan, the process proceeds to the next block at step 66. It is determined, at step 46, if the summary page for the block is good. If the summary page is good, the process proceeds through steps 54, step 68, and 66, as described above, until no more blocks remain.

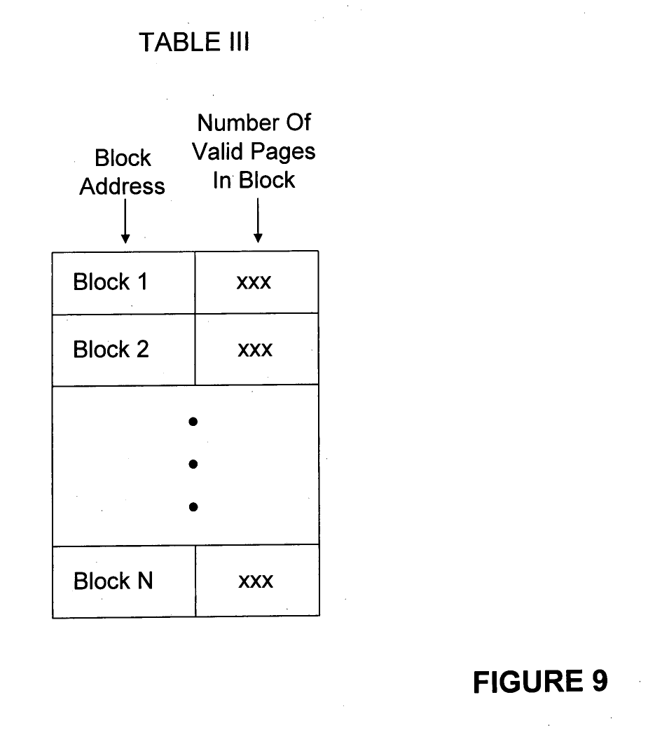

If it is determined (step 46) that the summary page for the block is not good, it is determined, at step 48, if the block is sealed. The seal portion of the metadata portion of page 0 is checked to determine if the block is sealed (see FIG. 5). If the distinctive pattern of the seal is detected, the block is sealed. If the block is sealed, the block is placed on the free list at step 56. The block is placed on the free list by updating the memory management data structure indicating the free status of each block, such as Table II and Table III for example (see FIG. 8 and FIG. 9). If the block is not sealed (step 48), it is determined if the block is defective at step 50. The bad block indicator (BBI) portions of pages 0 and 1 (see FIG. 5) are checked to determine if the block is defective. In an exemplary embodiment, the block is not defective if the BBI portions of pages 0 and 1 contain all binary 1s and the block is defective in all other cases. If the block is defective (step 50), the block is abandoned and the memory management data structure indicating available blocks, such as Table I for example (see FIG. 8), is updated accordingly.

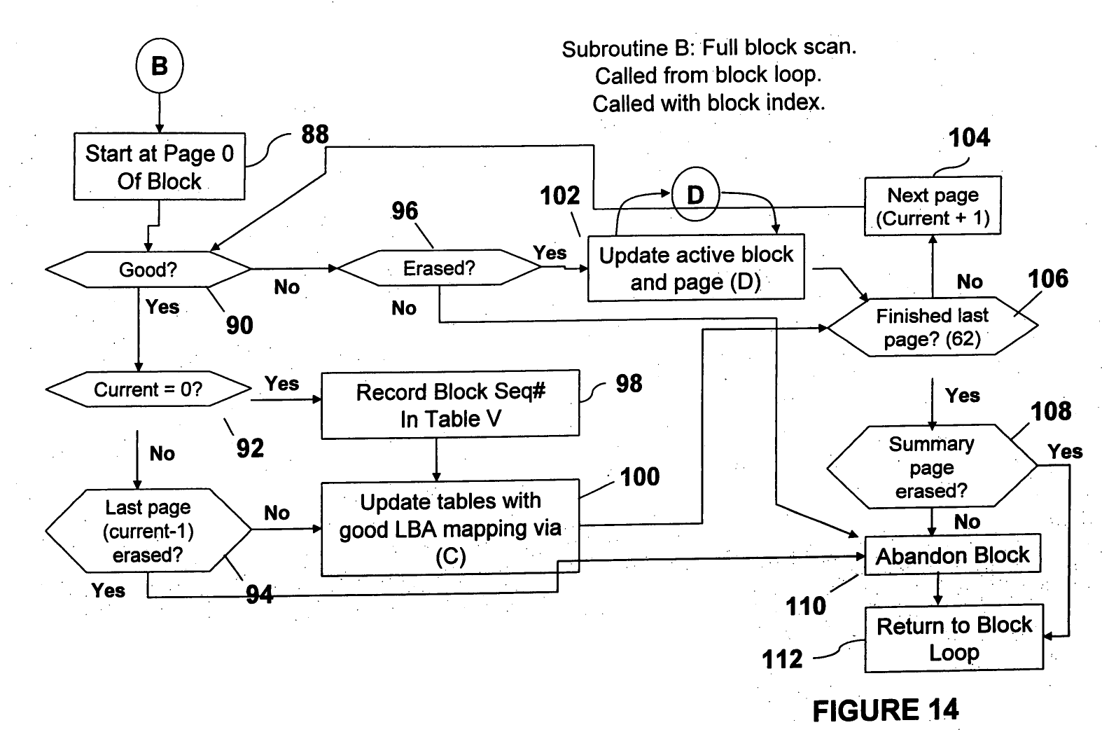

If it is determined (step 50) that the block is not defective, it is determined at step 52, if the block is erased. A block is deemed to be erased if every bit in the block is 1. If it is determined (step 52) that the block is erased, the block is sealed at step 60 and the block is placed on the free list at step 64. The block is placed on the free list at step 64 by updating the memory management data structure indicating the free status of each block, such as Table II and Table III for example (see FIG. 8 and FIG. 9). If it is determined (step 52) that the block is not erased, the pages of the block are scanned at step 62. In an exemplary embodiment, the block is scanned in accordance with the exemplary flow diagram depicted in FIG. 14.

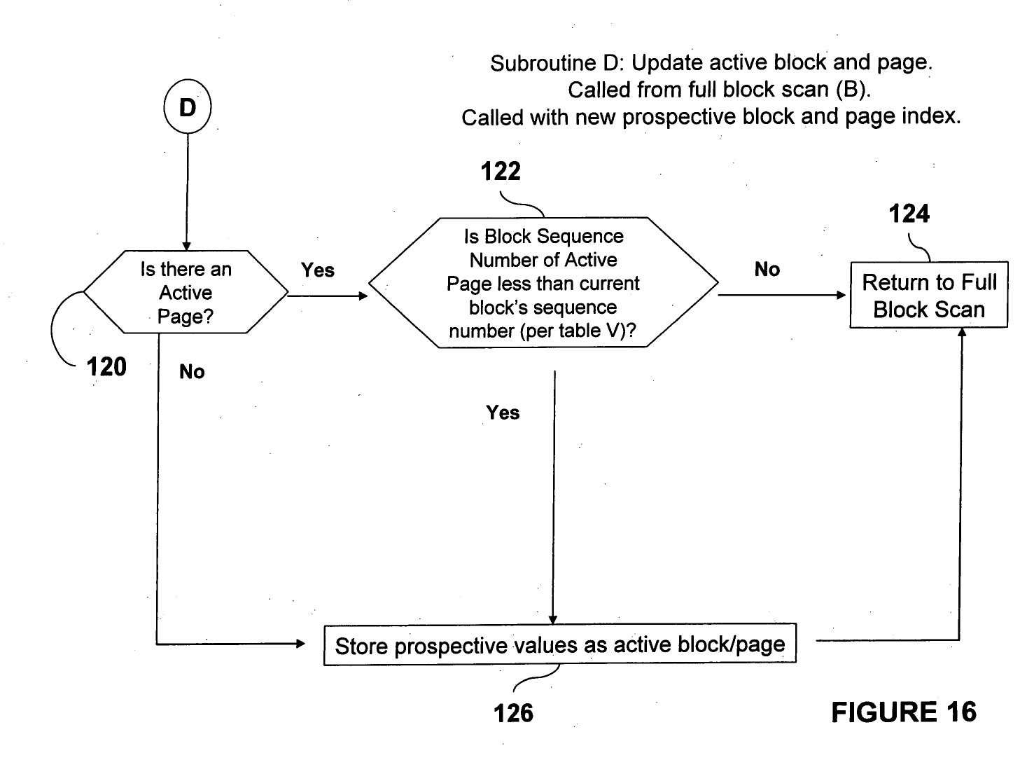

The block scan starts at page 0 at step 88. At step 90, it is determined if the page is good. The page is determined to be good if the ECC and the strong error detection algorithms result in no errors. If it is determined (step 90) that the page is not good, it is determined at step 96 if the page is erased (i.e., contains all 1's). If the page is not erased (step 96), the block is abandoned at step 110 and, as depicted at step 112, the process proceeds to step 62 of FIG. 12. If the page is erased (step 96), the active block and active page indicators are updated at step 102. In an exemplary embodiment, the active block and active page indicators are updated in accordance with the exemplary process depicted in FIG. 16. A page is designated as the active page if it is the first erased page in the block with the largest block sequence number and the block has not been abandoned. If an active block already has been designated, an active page is selected from the active block as described below. It is possible however, that an active block does not exist. This could be the result of, for example, power failing after a block was filled, but before the next write request arrives or before the summary page can be written. In either case, the last allocated block is completely full, and there is no active page.

At step 120, it is determined if there is an active page. If there is no active page (step 120), the current block and page are stored as prospective active block and active page, at step 126. If there is an active page (step 120), it is determined, at step 122, if the block sequence number of the active page is less than the current block's sequence number (as determined by Table V for example). If yes, the current block and page are stored as prospective active block and active page, at step 126. If no, as depicted at step 124, the process proceeds to step 102 of FIG. 14. It is determined at step 106 if the last page of the block has been scanned. If there are more pages to scan, the next page is accessed at step 104. The process proceeds to step 90 and, if the page is good, proceeds through step 96 and step 102 as described above.

If, at step 90, it is determined that the page is not good, it is determined if the current page is page 0 at step 92. If the current page is page 0, the block sequence number is recorded in the appropriate memory management data structure at step 98. In an exemplary embodiment, the block sequence number is recorded in Table V. Appropriate memory management data structures are updated with good LBAs at step 100. In an exemplary embodiment, Table I is updated in accordance with the exemplary process depicted in FIG. 16, as described above. It is determined at step 106 if the last page of the block has been scanned. If there are more pages to scan, the next page is retrieved at step 104, and the process proceeds to step 90 as described above.

If it is determined (step 92) that the current page is not page 0, it is determined, at step 94, if the previous page is erased. If it is determined (step 94) that the previous page is erased, the block is abandoned at step 110, and as depicted by step 112, the process proceeds to step 62 of FIG. 12. If it is determined (step 94) that the previous page is not erased, the appropriate memory management data structures are updated with good LBAs at step 100. In an exemplary embodiment, Table I is updated in accordance with the exemplary process depicted in FIG. 15, as described above. It is determined at step 106 if the last page of the block has been scanned. If there are more pages to scan, the next page is accessed at step 104, and the process proceeds to step 90 as described above.

Referring again to FIG. 12, at the conclusion of step 54, step 58, step 64, or step 62, it is determined, at step 68, if there are more blocks to be scanned. If there are more blocks to be scanned, the process proceeds to step 66 and continues as described above. If it is determined (step 68) that there are no more blocks to scan, the current block sequence number is set to the maximum block sequence number, excluding abandoned blocks. The appropriate memory management data structures are updated (Table III and Table V, for example) to reflect the setting of the current block's sequence number. At step 72, it is determined if the sequence number of the current active block is less than the maximum block sequence number. If no, the power up process is completed at step 76. If yes, the active block is zeroed at step 74. That is, the active block indicator is set to indicate that there is no active block.

In an exemplary embodiment, erasures are attempted to be distributed evenly across blocks of the flash memory. This process is referred to as wear leveling. In accordance with an exemplary wear leveling process, a number indicative of the number of times a block has been erased (erasure count) is written in the metadata portion of the summary page of each block. In an exemplary embodiment, the erasure count is written to summary page when the block is being sealed. The erasure count for each block is maintained in the memory management data structures and is recoverable from the summary page of each block during the construction of memory management data structures during power-up.

As mentioned above, while exemplary embodiments of memory management have been described in connection with various computing devices, the underlying concepts can be applied to any computing device or system capable of managing memory.

The various techniques described herein can be implemented in connection with hardware or software or, where appropriate, with a combination of both. Thus, the methods and apparatus for managing memory, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing memory management. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

The methods and apparatus for memory management also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention can invariably be a combination of hardware and software.

While memory management has been described in connection with the exemplary embodiments of the various figures, it is to be understood that other similar embodiments can be used or modifications and additions can be made to the described embodiments for performing the same functions of memory management without deviating therefrom. Therefore, memory management as described herein should not be limited to any single embodiment, but rather should be construed in breadth and scope in accordance with the appended claims.

What is claimed:

1. A method for managing memory, said method comprising:
accessing memory in accordance with a memory management data structure, said memory management data structure comprising information pertaining to said memory;
dynamically updating designated locations of said memory with information pertaining to memory status; and
dynamically updating said memory management data structure with information pertaining to memory status.

2. A method in accordance with claim 1, further comprising:
creating said memory management data structure in accordance with said information stored in said designated locations in said memory.

3. A method in accordance with claim 2, wherein:
said memory comprises flash memory;
said memory management data structure is stored in volatile memory; and
said memory management data structure is constructed each time power is applied to said volatile memory subsequent a lack of power to said volatile memory.

4. A method in accordance with claim 1, said memory comprising a plurality of blocks, each block comprising a plurality of pages, wherein said designated locations in said memory comprise:
a first designated page in each block, each first designated page of each respective block being indicative of:
a status of a respective block being one of good and bad; and
a respective block being one of erased and not erased; and
a second designated page in each block, each second designated page of each respective block being indicative of:
a relationship between a logical block address and each page of a respective block;
a validity status of portions of each page of a respective block; and
a block sequence number indicative of a number of times blocks in said memory have been erased.

5. A method in accordance with claim 4, further comprising constructing said memory management data structure, said act of constructing comprising:
reading each first designated page in each block;
constructing said memory management data structure in accordance with information contained in each read first designated page;
reading each second designated page in each block; and
constructing said memory management data structure in accordance with information contained in each read second designated page.

6. A method in accordance with claim 5, wherein:
said second designated page is read prior to attempting to read said second designated page; and
said first designated page is read only if an error occurs in reading said second designated page.

7. A method in accordance with claim 5, wherein said memory management data structure is reconstructed each time power is applied to said memory subsequent a lack of power to said memory.

8. A method in accordance with claim 5, said memory management data structure being indicative of an active page of said memory, wherein an active page is indicative of a next page to be written in response to a write command.

9. A method in accordance with claim 8, further comprising:
upon writing to said active page, updating said memory management data structure to be indicative of a location of a next active page, wherein said next active page comprises an erased page having a lowest page address in one of:
a block currently being accessed; and
if said block currently being access is full, a next available block.

10. A method in accordance with claim 1, said memory comprising a plurality of blocks and each block comprising a plurality of pages, wherein said memory management data structure comprises at least one of:
a data structure indicative of a relationship between logical block addresses and page addresses of said memory and a validity status of portions of each page of a respective block;
a data structure indicative of erased blocks available for writing;
a data structure indicative of a number of valid pages in each block;
a data structure indicative of a next page to be written in response to a write command; and
a data structure indicative of a block sequence number indicative of a number of times blocks in said memory have been erased.

11. An apparatus for managing memory, said apparatus comprising:
a first memory portion for comprising a memory management data structure for managing a second memory portion;
said second memory portion comprising a plurality of blocks, each block comprising a plurality of pages; and
a controller portion for:
controlling access to said second memory portion; and
constructing said memory management data structure.

12. An apparatus in accordance with claim 11, wherein:
said first memory portion comprises volatile memory; and
said second memory portion comprises non-volatile memory.

13. An apparatus in accordance with claim 11, wherein said second memory portion comprises flash memory.

14. An apparatus in accordance with claim 11, wherein said second memory portion comprises:
a first designated page in each block, each first designated page of each respective block being indicative of:
a status of a respective block being one of good and bad; and
a respective block being one of erased and not erased; and
a second designated page in each block, each second designated page of each respective block being indicative of:
a association between a logical block address and each page of a respective block;
a validity status of portions of each page of a respective block; and
a block sequence number indicative of a number of times a blocks in said memory have been erased.

15. An apparatus in accordance with claim 14, wherein said controller portion constructs said memory management data structure in said first memory portion in accordance with information contained in said first and second designated pages each time power is applied to said first memory portion subsequent a lack of power to said first memory portion.

16. An apparatus in accordance with claim 11, wherein said memory management data structure comprises at least one of:
a data structure indicative of a relationship between logical block addresses and page addresses of said second memory portion and a validity status of portions of each page of a respective block;
a data structure indicative of erased blocks available for writing;
a data structure indicative of a number of valid pages in each block;
a data structure indicative of a next page to be written in response to a write command; and
a data structure indicative of a block sequence number indicative of a number of times blocks in said memory have been erased.

17. A computer-readable medium having computer-executable instructions for performing the acts of:
creating a memory management data structure in a first memory in accordance with information stored in designated locations in a second memory, wherein said memory management data structure is created each time power is applied to said first memory subsequent a lack of power to said first memory;
accessing said second memory in accordance with said memory management data structure, said memory management data structure comprising information pertaining to said second memory;
dynamically updating designated locations of said second memory with information pertaining to second memory status; and
dynamically updating said memory management data structure with information pertaining to second memory status.

18. A computer-readable medium in accordance with claim 17, wherein said second memory comprises a plurality of blocks and each block comprises a plurality of pages, said computer-readable medium having further computer-executable instructions for:
reading a first designated page in each respective block, wherein a first designated page of each respective block is indicative of:
a status of a respective block being one of good and bad; and
a respective block being one of erased and not erased;
constructing said memory management data structure in accordance with information contained in each read first designated page;
reading a second designated page in each respective block, wherein a second designated page of each respective block is indicative of:
a relationship between a logical block address and each page of a respective block;
a validity status of portions of each page of a respective block; and
a block sequence number indicative of a number of times blocks in said memory have been erased; and
constructing said memory management data structure in accordance with information contained in each read second designated page.

19. A computer-readable medium in accordance with claim 17, wherein said memory management data structure is indicative of an active page of said second memory, said active page being indicative of a next page to be written in response to a write command, said computer-readable medium having further computer-executable instructions for:
upon writing to said active page, updating said memory management data structure to be indicative of a location of a next active page, wherein said next active page comprises an erased page having a lowest page address in one of:
a block currently being accessed; and
if said block currently being accessed is full, a next available block.

20. A computer-readable medium in accordance with claim 17, said second memory comprising a plurality of blocks and each block comprising a plurality of pages, wherein said memory management data structure comprises at least one of:
a data structure indicative of a relationship between logical block addresses and page addresses of said second memory and a validity status of portions of each page of a respective block;
a data structure indicative of erased blocks available for writing;
a data structure indicative of a number of valid pages in each block;
a data structure indicative of a next page to be written in response to a write command; and
a data structure indicative of a block sequence number indicative of a number of times blocks in said memory have been erased.
